(19) United States
(12) Patent Application Publication
(10) Pub. No.: US 2018/0163936 A1
(43) Pub. Date: Jun. 14, 2018

(54) Surface Mountable Flame-less Candlestick System

(71) Applicant: Lorna Hazzard, Huntington, NY (US)

(72) Inventor: Lorna Hazzard, Huntington, NY (US)

(21) Appl. No.: 15/815,538

(22) Filed: Nov. 16, 2017

Related U.S. Application Data
(60) Provisional application No. 62/434,309, filed on Dec. 14, 2016.

(51) Int. Cl. F21S 9/02; F21V 21/092; F21V 21/30; F21V 35/00

(52) U.S. Cl. CPC F21S 9/02; F21V 21/092; F21W 2121/00; F21V 35/00; F21V 21/30

(57) ABSTRACT

An elongate member for providing illumination includes a body, a light emitting element, and a suction apparatus. The suction apparatus is coupled to the elongate member and configured to attach the elongate member to a surface and allow users to decoratively place candles on windows that have no ledge.

### CROSS REFERENCE TO RELATED APPLICATION

The present application is related to and claims priority to U.S. Provisional Patent Application No. 62/434,309 filed Dec. 14, 2016, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### 1. Field of the Invention

The present invention relates generally to the field of illumination and more specifically relates to surface-mountable illumination means.

### 2. Description of Related Art

Many individuals enjoy the classic look of candles placed in windows. However, without a windowsill or ledge there is not a suitable surface to place the candle on. Users may attempt to tape a candle to the glass however, this can result in the candle falling off and tape residue being left on the window. Individuals without a windowsill often go without candles because there is not a suitable alternative. A suitable solution is desired.

U.S. Pat. No. 4,839,784 to Ling-Yung Lin relates to a candle-like lighting device. The described candle-like lighting device includes an electrically powered candle-like lighting device having a candle body with a bulb disposed at the top thereof, which is mounted on a candle holder pivotably adjusted in a plane within 180 degrees. The candle holder is further secured to a candle base provided with a sucker received at the concaved bottom thereof in such a manner that the base can be spun freely with respect to the fixed sucker, thereby the whole light assembly can be fixed on any surface, horizontal, vertical or inclined with the candle body adjustably posed within a half-sphere range.

### BRIEF SUMMARY OF THE INVENTION

In view of the foregoing disadvantages inherent in the known illumination art, the present disclosure provides a novel surface mountable flame-less candlestick system. The general purpose of the present disclosure, which will be described subsequently in greater detail, is to provide an electrically powered flame-less candlestick that can be removably attached to a window, mirror or other similar surface. The candlestick uses a suction cup to allow users to decoratively place candles on windows that have no ledge.

An elongate member for providing illumination is disclosed herein. The elongate member for providing illumination includes a body, a light emitting element, and a suction apparatus. The body includes an upper end and a lower end. The light emitting element may be removably attached to the upper end of the body. The suction apparatus is coupled to the elongate member and configured to attach the elongate member to a surface. The elongate member is configured for providing illumination and allows users to decoratively place candles on windows, mirrors or other surfaces.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a surface mountable flame-less candlestick system, constructed and operative according to the teachings of the present disclosure.

FIG. 1 is a perspective view of the elongate member for providing illumination during an ‘in-use’ condition, according to an embodiment of the disclosure.

FIG. 2 is a perspective view of the elongate member for providing illumination of FIG. 1, according to an embodiment of the present disclosure.

FIG. 3 is a perspective view of the elongate member for providing illumination of FIG. 1, according to an embodiment of the present disclosure.

FIG. 4 is a perspective view of the elongate member for providing illumination of FIG. 1, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to an illumination device and means and more particularly to a surface mountable flame-less candlestick system as used to improve illumination means and have a suction cup support.

Generally, the present invention provides a battery-operated or solar powered candlestick that can be attached to a window, mirror, or similar surface. It uses a suction cup which allows users to decoratively place candles on windows that have no ledge. This allows consumers to achieve the elegant look of candles placed in windows. The present invention includes white bulbs or may be available with interchangeable colored bulbs for holidays, parties, personal décor, and more. The present invention may also include the capability to play pre-recorded music when initiated by a user. Different colored candle sticks and decals may be employed.

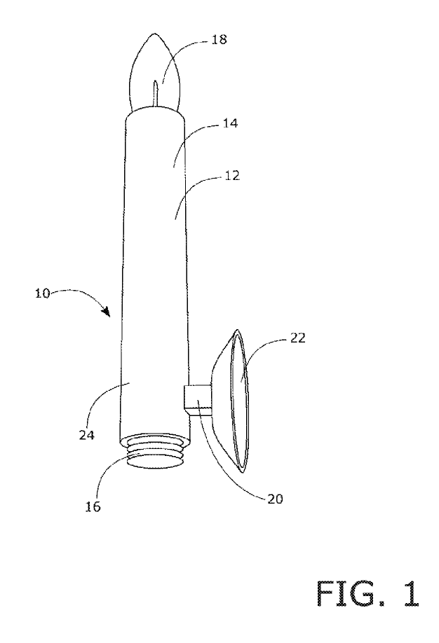

Referring now more specifically to the drawings by numerals of reference, there is shown in FIGS. 1-4, various views of an elongate member 10 for providing illumination. FIG. 1 shows an elongate member 10 for providing illumination during an ‘in-use’ condition, according to an embodiment of the present disclosure.

As illustrated, the elongate member 10 for providing illumination may include a body 12, a light emitting element 18, a base 26, and a suction apparatus 20. The body 12 includes an upper end 14 and a lower end 16. The light emitting element 18 may be removably attached to the upper end 14 of the body 12. The suction apparatus 20 is coupled to the elongate member 10 and configured to attach the elongate member to a surface. The elongate member 10 is configured for providing illumination. The suction apparatus 20 is removably attached to a lower portion of the body 24, the lower portion being located above the lower end 16. The suction apparatus 20 is removably attached to the lower portion of the body 24 by an attachment means selected from the group consisting of an adhesive, a magnet, a hook and fastener, a nail, and a screw. The elongate member 10 for providing illumination may further comprise a base 26; the base 26 being removably attached to the lower portion of the body 24. The suction apparatus 20 may be removably attached to the base 26. The suction apparatus 20 is removably attached to the base 26 by an attachment means selected from the group comprising, to an adhesive, a magnet, a hook and fastener, a nail, and a screw.

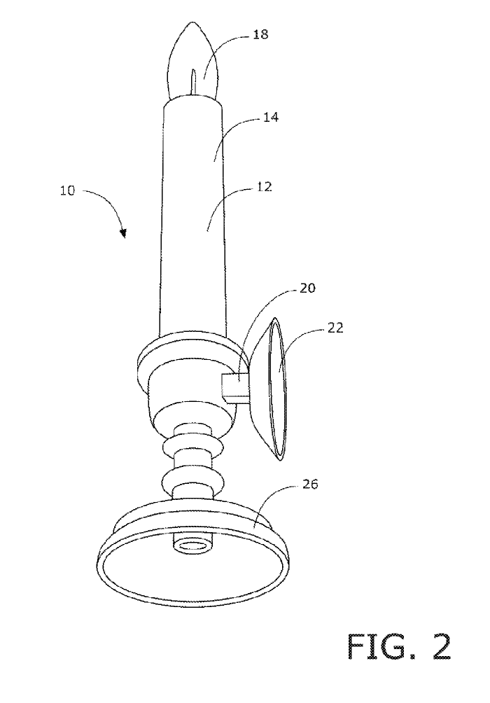

FIG. 2 shows a perspective view of the elongate member 10 for providing illumination of FIG. 1, according to an embodiment of the present disclosure. As above, the elongate member 10 for providing illumination may include the body 12, the light emitting element 18, and the suction apparatus 20. The suction apparatus 20 may comprise a suction cup 22 or other suitable fastening means. The suction apparatus is made of an elastic, flexible material. The elastic, flexible material may include silicone, Nitrile, Viton, vinyl, urethane or other suitable materials. Other attachments means may be used. In a preferred embodiment, the suction apparatus 20 is removably attached to a length of the body 12. The length of the body 12 is defined by a distance between the upper end 14 and the lower end of the body 16. The suction apparatus 20 is removably attached to the length of the body 12 by an attachment means selected from the group consisting of an adhesive, a magnet, a hook and fastener, a nail, and a screw.

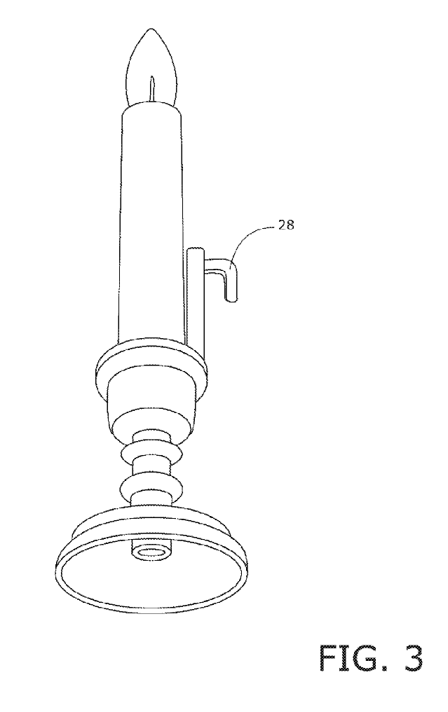

FIG. 3 shows a perspective view of the elongate member 10 for providing illumination of FIG. 1, according to an embodiment of the present disclosure. As above, the elongate member 10 for providing illumination may include the body 12, the light emitting element 18, and the suction apparatus 20. The elongate member 10 for providing illumination may further comprise a base 26; the base 26 being removably attached to the lower portion of the body 24. The suction apparatus 20 may be removably attached to the base 26. The suction apparatus 20 is removably attached to the base 26 by an attachment means selected from the group consisting of: to an adhesive, a magnet, a hook and fastener, a nail, and a screw.

The device may be attached to a surface such as a window, a mirror, or the like for providing illumination means. The body 12 comprises a candlestick and the base 26 is a candleholder. The illumination is provided by a light bulb. The light bulb is selected from the group consisting of an incandescent light bulb, an LED light bulb, a halogen light bulb, and a fluorescent light bulb. The light emitting element 18 may be battery-operated or solar-powered.

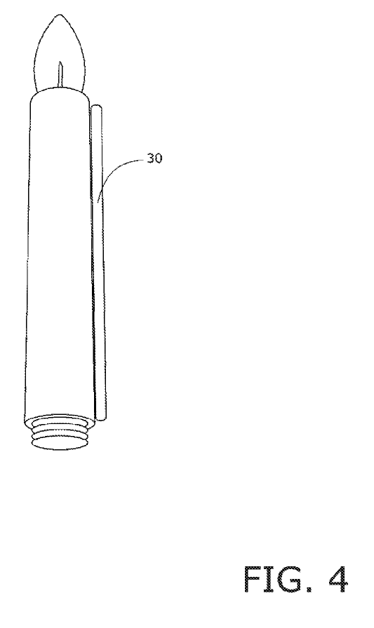

FIG. 4 shows a perspective view of the elongate member 10 for providing illumination of FIG. 1, according to an embodiment of the present disclosure. As above, the elongate member 10 for providing illumination may include the body 12, the light emitting element 18, and the suction apparatus 20. In a preferred embodiment the elongate member 10 for providing illumination comprises a body 12, the body 12 having an upper end 14 and a lower end 16; a light emitting element 18, the light emitting element 18 being removably attached to the upper end of the body 14; a suction apparatus 20; the suction apparatus 20 coupled to the elongate member 10 and configured to attach the elongate member 10 to a surface.

The suction apparatus 20 may include a suction cup 22; the suction cup 22 preferably being made of an elastic, flexible material. The elastic, flexible material may be selected from the group consisting of silicone, nitrile, viton, vinyl, and urethane. The suction apparatus 20 is removably attached to the lower end of the body 16 by an attachment means selected from the group comprising, an adhesive, magnet, hook and fastener, nail and screw; a base, the base being removably attached to the lower portion of the body 24. The suction apparatus 20 is removably attached to the base. The surface is a window. The body 12 is a candlestick. The light emitting element 18 is a light bulb. The light bulb is selected from the group consisting of an incandescent light bulb, an LED light bulb, a halogen light bulb, and a fluorescent light bulb. The base 26 is a candleholder; and the light emitting element 18 is battery-operated.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. An elongate member for providing illumination, said elongate member comprising:
a body, said body having an upper end and a lower end;
an interchangeable, colored light emitting element, said interchangeable, colored light emitting element being removably attached to said upper end of said body and having an etching on a surface of said interchangeable, colored light emitting element;
a suction apparatus, said suction apparatus coupled to the elongate member and configured to removably attach said elongate member to a surface; and
wherein said elongate member is configured for providing illumination.

2. The elongate member for providing illumination of claim 1, wherein said suction apparatus is selected from the group consisting of a suction cup, a hook suction, and a long suction, said suction apparatus being made of an elastic, flexible material.

3. The elongate member for providing illumination of claim 2, wherein said elastic, flexible material is selected from the group consisting of silicone, nitrile, viton, vinyl, and urethane.

4. The elongate member for providing illumination of claim 1, wherein said suction apparatus is removably attached to a lower portion of said body, said lower portion being located above said lower end.

5. The elongate member for providing illumination of claim 2, wherein said suction apparatus is removably attached to said lower portion of said body by an attachment means selected from the group consisting of an adhesive, a magnet, a hook and fastener, a nail and a screw.

6. The elongate member for providing illumination of claim 1, wherein said suction apparatus is removably attached to a length of the body.

7. The elongate member for providing illumination of claim 3, wherein said length of said body is defined by a distance between said upper end and said lower end of said body.

8. The elongate member for providing illumination of claim 5, wherein said suction apparatus is removably attached to said length of said body by an attachment means selected from the group consisting of an adhesive, a magnet, a hook and fastener, a nail and a screw.

9. The elongate member for providing illumination of claim 1, further comprising a base, said base being removably attached to said lower end of said body.

10. The elongate member for providing illumination of claim 7, wherein said suction apparatus is removably attached to said base.

11. The elongate member for providing illumination of claim 8, wherein said suction apparatus is removably attached to said base by an attachment means selected from the group consisting of to an adhesive, a magnet, a hook and fastener, a nail and a screw.

12. The elongate member for providing illumination of claim 1, wherein said surface is a window.

13. The elongate member for providing illumination of claim 1, wherein said surface is a mirror.

14. The elongate member for providing illumination of claim 1, wherein said body is a candlestick.

15. The elongate member for providing illumination of claim 1, wherein said light emitting element is a light bulb.

16. The elongate member for providing illumination of claim 13, wherein said light bulb is selected from the group consisting of an incandescent light bulb, an LED light bulb, a halogen light bulb, and a fluorescent light bulb.

17. The elongate member for providing illumination of claim 7, wherein the base is a candleholder.

18. The elongate member for providing illumination of claim 7, wherein the light emitting element is battery-operated.

19. The elongate member for providing illumination of claim 1, wherein the light emitting element is solar-powered.

20. An elongate member for providing illumination, said elongate member comprising:
a body, said body having an upper end and a lower end;
a light emitting element, said light emitting element being removably attached to said upper end of said body;
a suction apparatus, said suction apparatus coupled to the elongate member and configured to attach said elongate member to a surface;
a music player configured to may music;
wherein the suction apparatus includes a suction cup, said suction cup being made of an elastic, flexible material;
wherein said suction apparatus is removably attached to said lower portion of said body by an attachment means, said base being removably attached to said lower end of said body;
wherein said suction apparatus is removably attached to said base;
wherein the surface is a window; wherein the body is a candlestick;
wherein the light emitting element is a light bulb; and
wherein the base is a candleholder; and wherein the light emitting element and said music player are battery-operated.
